(19) United States
(12) Patent Application Publication
(10) Pub. No.: US 2011/0143236 A1
(43) Pub. Date: Jun. 16, 2011

(54) HYDROGEN ENGINE

(76) Inventor: Geoffrey McCue, Lawrence, KS (US)

(21) Appl. No.: 12/970,498

(22) Filed: Dec. 16, 2010

Related U.S. Application Data
(60) Provisional application No. 61/286,930, filed on Dec. 16, 2009.

(51) Int. Cl. H01M 8/06; H02N 2/18; H02J 7/00; H02K 7/18; F02B 65/00

(52) U.S. Cl. 429/422; 310/339; 320/101; 290/1 A; 123/3

(57) ABSTRACT

An engine having an electrolysis system that is powered, at least in part, by multiple piezoelectric generators, to generate a minimum amount of hydrogen necessary to fuel the engine as required by the engine to operate so that only the minimal amount of hydrogen exists at any time regardless of operating status of the engine.

### CROSS-REFERENCE TO RELATED APPLICATION

The present application claims priority to and is a non-provisional filing of U.S. Patent Application No. 61/286,930 filed Dec. 16, 2009, the disclosure of which is incorporated by reference in its entirety.

### BACKGROUND

1. Field of the Invention

The present inventive concept relates generally to an engine to supply power. More specifically, embodiments of the present inventive concept concern an engine having an electrolysis system that is powered, at least in part, by multiple piezoelectric generators, to generate hydrogen to fuel the engine as needed.

2. Description of the Related Art

No energy generation or conversion system or “engine” is completely efficient and there is always a certain amount of unutilized energy. Consequently, a cleaner, renewable engine concept is desirable.

An internal combustion engine is a proven means of providing power for use in industries such as automotive and power generation via utilizing gasoline or diesel fuels. However, a primary problem with conventional gasoline or diesel combustion engines is that they require fossil fuels that are not renewable and contribute to pollution. Consequently, a fuel that is renewable and does not contribute to pollution is desirable.

Hydrogen is, for many conventional applications, a feasible replacement for conventional fuels such as oil, natural gas, and gasoline. Hydrogen burns respectively cleaner than these fuels and is relatively easy to produce. However, hydrogen is highly combustible, so storage and dispensing of hydrogen are extremely dangerous and costly. As such, the aforementioned benefits of utilizing hydrogen in place of conventional fuels do not outweigh the aforementioned problems of such.

### SUMMARY

The following summary is provided to indicate the nature of the subject matter disclosed herein. While certain aspects of the present inventive concept are described below, the summary is not intended to limit the scope of the present inventive concept.

Embodiments of the present inventive concept provide a hydrogen engine that does not suffer from the problems and limitations of conventional engines such as those set forth above.

The present inventive concept provides, in its simplest form, an engine having an electrolysis system that is powered, at least in part, by multiple piezoelectric generators, to generate a minimum amount of hydrogen necessary to fuel the engine as required by the engine to operate so that only the minimal amount of hydrogen exists at any time regardless of operating status of the engine.

The aforementioned aspects may be achieved in one aspect of the present inventive concept by providing a power generating system including an engine that may be operable to generate power, and a water-to-hydrogen generator connected to the engine that may be operable to generate and supply fuel to the engine at a rate that is equal to a rate required by the engine to run so that no excess fuel is generated. The present inventive concept may include at least one vibration electrical generator that may be operable to capture vibration energy from the engine, convert the vibration energy into electricity, and transmit the electricity to power the water-to-hydrogen generator. The at least one vibration electrical generator may include one of the following vibration electrical generator configurations: (i) a first vibration electrical generator positioned directly on the engine to capture vibration energy transmitted directly from the engine, (ii) a second vibration electrical generator positioned on a part other than the engine to capture vibration energy transmitted indirectly from the engine, and (iii) a first vibration electrical generator positioned directly on the engine to capture vibration energy transmitted directly from the engine and a second vibration electrical generator positioned on a part other than the engine to capture vibration energy transmitted indirectly from the engine. The part may be one of a vehicle hood, vehicle roof, vehicle fender, vehicle door panel, and vehicle axle.

The present inventive concept may include a battery connected to the engine and the at least one vibration electrical generator, the battery may be operable to store electricity received from the at least one vibration electrical generator and to supply start-up power to the engine. The present inventive concept may include at least one solar collector that may be operable to capture solar energy from an external source and convert the solar energy into electricity. The present inventive concept may include a battery connected to the engine and the at least one solar collector, the battery may be operable to store electricity received from the solar collector and to supply start-up power to the engine.

The present inventive concept may include a fuel cell connected to the engine and the water-to-hydrogen generator, the fuel cell operable to receive fuel from the water-to-hydrogen generator, produce electricity from the fuel received, and to supply the electricity to the engine. The present inventive concept may include an alternator connected to the engine, the battery, and the water-to-hydrogen generator, the alternator operable to be powered by the engine, to generate electricity, and to transmit the electricity to the battery and the water-to-hydrogen generator. The engine may be one of a hydrogen combustion engine, a hydrogen combustion engine and an electric engine, and an electric engine, and the fuel generated by the water-to-hydrogen generator is hydrogen.

The aforementioned aspects may be achieved in another aspect of the present inventive concept by providing a method of generating power, the method including an engine that may be operable to generate power, and generating a supply of fuel for the engine via a water-to-hydrogen generator supply, the supply of fuel may be generated at a rate that is equal to a rate required by the engine to run so that no excess fuel is generated. The present inventive concept may include the steps of (i) capturing vibration energy created by the engine, (ii) converting the vibration energy into electricity, and (iii) transmitting the electricity to power the water-to-hydrogen generator via at least one vibration electrical generator. The at least one vibration electrical generator may include one of the following vibration electrical generator configurations: (i) a first vibration electrical generator positioned directly on the engine to capture vibration energy transmitted directly from the engine, (ii) a second vibration electrical generator positioned on a part other than the engine to capture vibration energy transmitted indirectly from the engine, and (iii) a first vibration electrical generator positioned directly on the engine to capture vibration energy transmitted directly from the engine and a second vibration electrical generator positioned on a part other than the engine to capture vibration energy transmitted indirectly from the engine. The part may be one of a vehicle hood, vehicle roof, vehicle fender, vehicle door panel, and vehicle axle.

The present inventive concept may include the steps of (i) storing electricity received from the engine and the at least one vibration electrical generator in a battery, and (ii) supplying start-up power to the engine from the battery. The present inventive concept may include the steps of (i) capturing solar energy from an external source, and (ii) convert the solar energy into electricity via at least one solar collector. The present inventive concept may include the steps of (i) storing electricity received from the solar collector in a battery, and (ii) supplying start-up power to the engine from the battery. The present inventive concept may include the steps of (i) receiving fuel from the water-to-hydrogen generator in a fuel cell, (ii) using the fuel received to produce electricity, and (iii) powering the engine with the electricity. The present inventive concept may include the steps of (i) powering an alternator by the engine to produce electricity, (ii) charging the battery with the electricity produced by the alternator, and (iii) powering the water-to-hydrogen generator with the electricity produced by the alternator. The engine may be one of a hydrogen combustion engine, a hydrogen combustion engine and an electric engine, and an electric engine, and the fuel generated by the water-to-hydrogen generator is hydrogen.

Other aspects and advantages of the present inventive concept will be apparent from the following detailed description of the preferred embodiments and the accompanying drawings figures.

### BRIEF DESCRIPTION OF THE FIGURES

Embodiments of the present inventive concept are described herein with reference to the following drawing figures, wherein:

FIG. 1 is a schematic view with flow chart of a first embodiment of present inventive concept having a piezoelectric (PZT) vibration harvesting system that captures low voltage,

FIG. 2 is a schematic view with flow chart of a second embodiment of the present inventive concept.

FIG. 2a is a schematic view with flow chart of a third embodiment of the present inventive concept.

FIG. 3 illustrates the present inventive concept, as illustrated in FIGS. 1, 2, and 3, in use with a vehicle.

FIG. 4 illustrates the present inventive concept, as illustrated in FIGS. 1, 2, and 3, in use with a vehicle.

FIG. 5 illustrates the present inventive concept, as illustrated in FIGS. 1, 2, and 3, in use with a vehicle.

### DETAILED DESCRIPTION

The present inventive concept is susceptible of embodiment in many forms. While the drawings illustrate, and the specification describes, certain embodiments of the invention, it is to be understood that such disclosure is by way of example only. The principles of the present inventive concept are not limited to the particular disclosed embodiments.

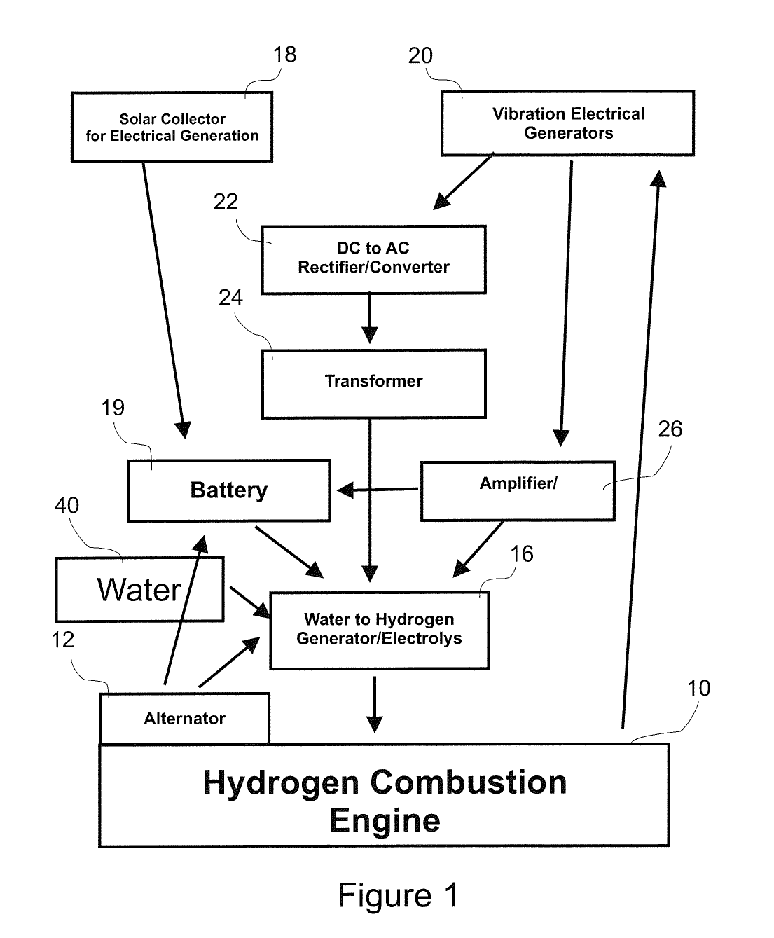

With initial reference to FIG. 1, a first embodiment of the present inventive concept is illustrated. In this embodiment, the present inventive concept includes a hydrogen combustion engine 10 that is connected to an alternator 12. The alternator 12 supplies power to both a water-to-hydrogen generator 14 and a battery 16.

The battery 14 is operable to store and supply power necessary for operations such as, but not limited to, starting the engine 10. It is foreseen that the battery 14 may supply power for ancillary operations, such as but not limited to, running gauges (not illustrated) that indicate, among other things, remaining charge of the battery 14 or “battery life.” Once the engine 10 is started, the alternator 12 is operable to charge or recharge the battery 14, e.g., to its maximum charge.

The water-to-hydrogen generator 16 is operable to produce hydrogen through electrolysis. The water-to-hydrogen generator 16 includes a chamber in which electrolysis is performed and may be connected to one or more additional chambers (not illustrated) for storing elements necessary to produce hydrogen, e.g., water. Upon filling the chamber with the necessary elements, the water-to-hydrogen generator 16 may be activated so that electrolysis is performed and hydrogen is generated. The one or more additional chambers may be operable to provide a continuous supply of the necessary elements to the chamber to prevent the necessary elements from becoming depleted, for instance, as hydrogen is generated.

The battery 14 may also be charged and/or recharged via a solar collector 18 that is positioned in an area that exposes the solar collector 18 to solar energy, e.g., on a top of a vehicle. The solar collector 18 is operable to generate electricity by converting solar energy to electrical energy. It is foreseen that the solar collector 18 may be a conventional solar cell.

The engine 10 vibrates during operation thereof. Additionally, the engine 10 is operable to power an apparatus, e.g., a vehicle (not illustrated), which vibrates during operation and/or movement thereof. Consequently, the engine 10 generates vibration energy both directly and indirectly. To capture the vibration energy, the present inventive concept has a plurality of vibration-reactive piezoelectric generators 20 that are mounted directly on the engine 10 and/or on miscellaneous parts of the apparatus, e.g., a vehicle body party such as an engine cover or “hood,” axle, strut, or the like, that are subject to the indirect and/or direction vibration energy. The piezoelectric generators 20 are thin, lightweight, and are sized and shaped to a contour of a surface of the engine and/or miscellaneous parts and to cover a maximum area of the surface. The piezoelectric generators 20 are operable to capture the indirect and/or direction vibration energy and convert such to electrical energy for the purpose of, for instance, charging the battery 14.

Because the vibration energy collected by the piezoelectric generators 20 may be minimal, it is foreseen that the present inventive concept may utilize one or more option elements to increase voltage and/or energy output, such as amplifiers, transformers and inverters.

The piezoelectric generators 20 are each individually and independently electrically connected to a DC-to-AC rectifier/converter 22 to convert the electrical energy captured by each of the piezoelectric generators 20 from direct current to alternating current. The DC-to-AC rectifier/converter 22 is electrically connected to a transformer 24 and transmits alternating current thereto. The transformer 24 is operable to change a voltage of the electricity from the DC-to-AC rectifier/converter 22 to an ideal voltage. The transformer 24 is electrically connected to the water-to-hydrogen generator 16 and is operable to provide power thereto in addition to and/or instead of the power provided by the alternator 12, as previously discussed.

The piezoelectric generators 20 may also be electrically connected to an amplifier-controller 26 that is operable to control and/or amplify electricity transmitted from the piezoelectric generators 20. The amplifier-controller 26 may be connected to the battery 14 and/or the water-to-hydrogen generator 16 to provide power in addition to and/or instead of the power provided by the alternator 12, as previously discussed. The amplifier-controller 26 is controllable to permit selective output of the amplified electricity transmitted from the amplifier-controller 26. In this manner, the piezoelectric generators 20 enable immediate and abundant generation of electricity to produce the hydrogen necessary to run the engine 10 without requiring a large storage system.

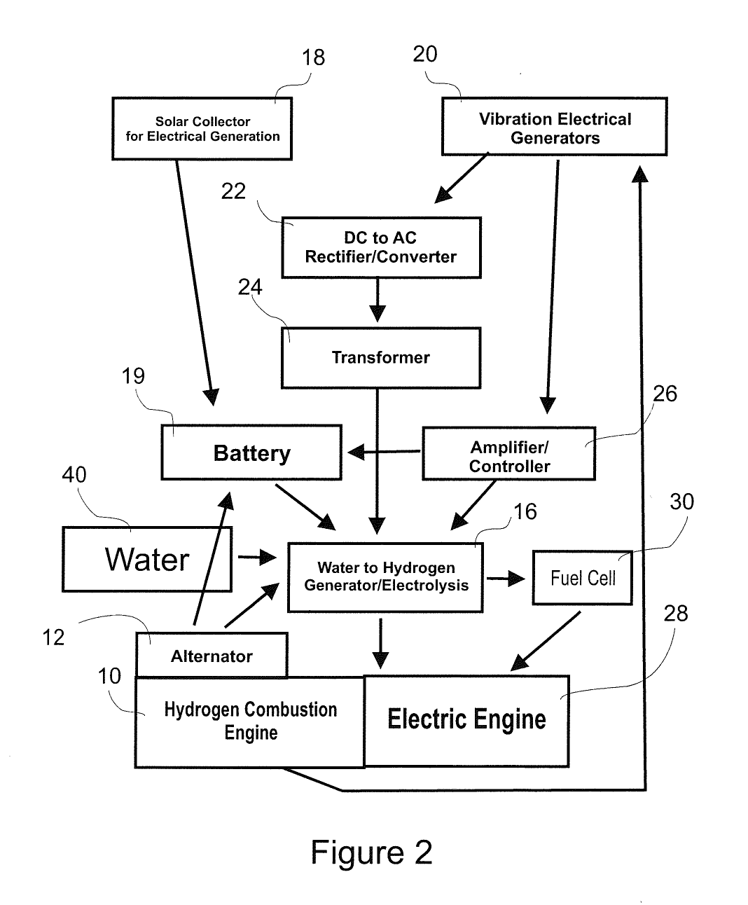

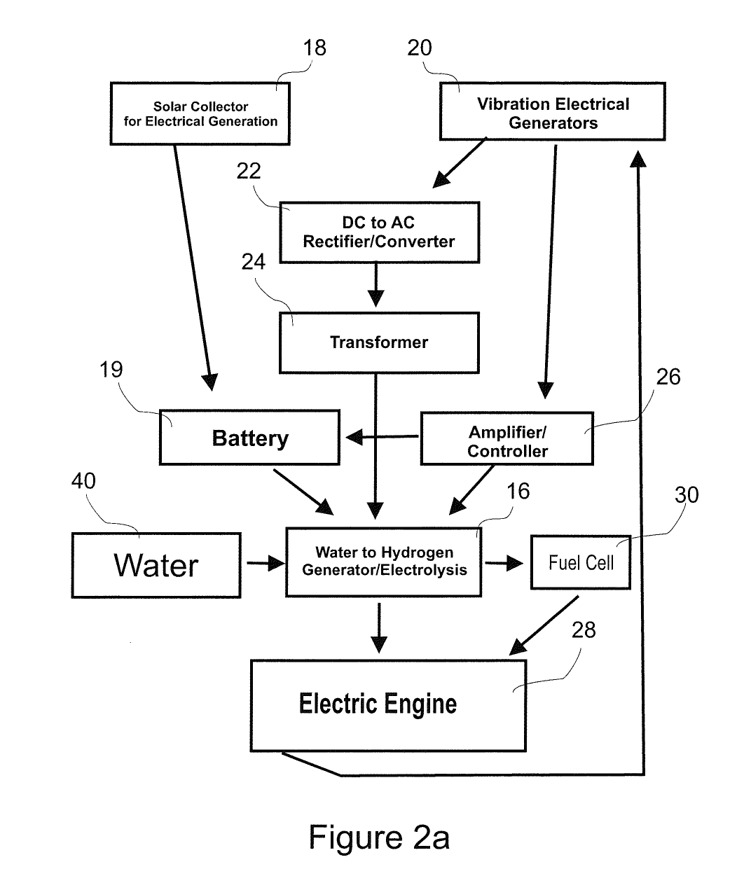

Now turning to FIG. 2, a second embodiment of the present inventive concept is illustrated. The second embodiment contains all of the elements of the first embodiment that operate as discussed in the first embodiment except that the water-to-hydrogen generator 16 is connected to and operable to power an electric engine 28 instead of the hydrogen engine 10.

Additionally, this embodiment has a fuel cell 30 that is connected to the water-to-hydrogen generator 16 and the electric engine 28. The fuel cell 30 is operable to receive the hydrogen from the water-to-hydrogen generator 16, to produce electricity using the hydrogen received from the water-to-hydrogen generator 16, e.g., via a chemical reaction as the hydrogen passes through components (not illustrated) in the fuel cell 30, and to supply the electric engine 28 with electricity produced as needed and/or on demand to operate, for instance, to start the electric engine 28.

Now turning to FIG. 2a, a third embodiment of the present inventive concept is illustrated. The third embodiment contains all of the elements of the second embodiment that operate as discussed in the second embodiment except that the hydrogen engine 10 and the alternator 12 are omitted. Thus, the fuel cell 30 is operable to power the electric engine 28, as discussed previously.

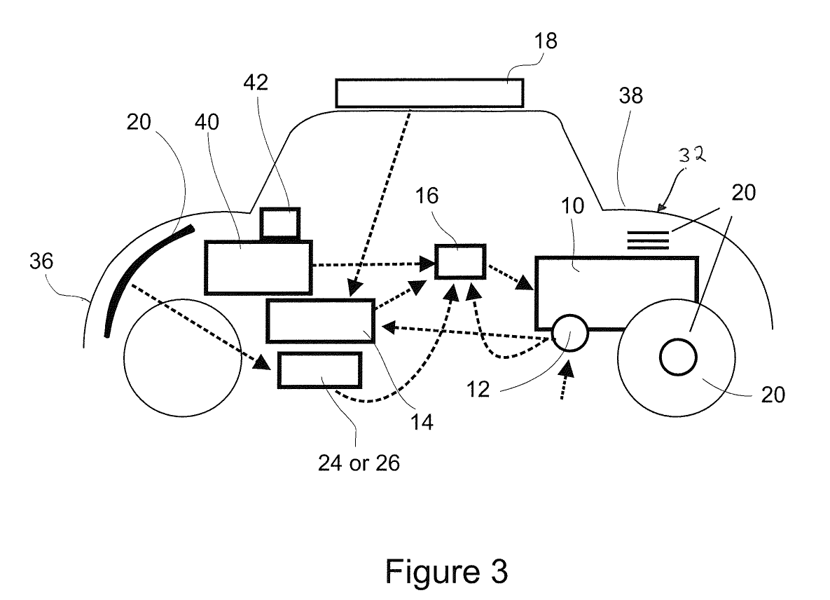

Now turning to FIGS. 3-5, one or more of the aforementioned embodiments are illustrated in use with a vehicle 32. Additionally, various alternative elements illustrated. The solar collector 18 is secured to a roof of the vehicle 32, which advantageously exposes the solar collector 18 to solar energy. Piezoelectric generators 20 are secured to body parts of the vehicle 32, that is, a trunk 36 and hood 38 of the vehicle, which advantageously exposes the piezoelectric generators 20 to vibration energy.

A water supply 40 is connected to the water-to-hydrogen generator 16 to supply the water-to-hydrogen generator 16 with water for use during electrolysis. A catalyst injector 42 is also provided to facilitate the electrolysis process, for instance, by heating the water and/or facilitating injection of a component into the water to assist the water-to-hydrogen generator 16.

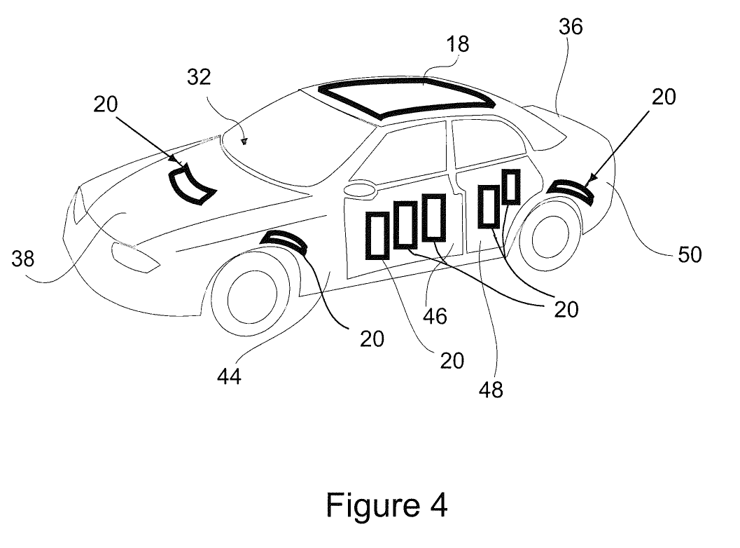

FIG. 4 illustrates a plurality of piezoelectric generators 20 secured to parts of the vehicle 32, that is, the trunk 36, hood 38, front fender 44, front door 46, rear door 48, and rear fender 50, for the purpose of capturing vibration energy during operation. It is foreseen that the piezoelectric generators 20 may be connected to any surface of the engine 10, engine 28, and/or parts of the vehicle 32 without deviating from the present inventive concept.

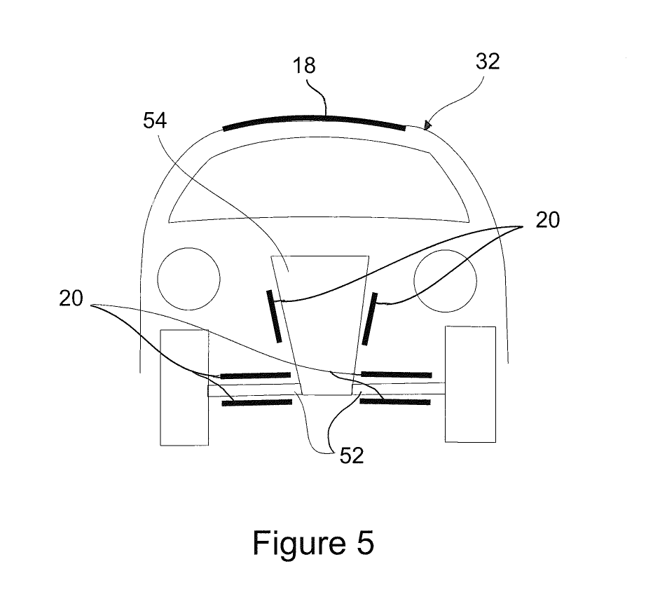

FIG. 5 illustrates a plurality of piezoelectric generators 20 secured to internal drive parts of the vehicle 32, that is, an axle 52 and an engine 54, for the purpose of capturing vibration energy transmitted during operation. It is foreseen that the engine 54 may be engine 10 and/or engine 28.

The present inventive concept may be employed in other applications such as with internal combustion generators, wind turbines, water movement, as well as transformers and power lines that are connected to a system/grid.

The present inventive concept incorporates by reference herein in its entirety the disclosure of U.S. Patent Application No. 2005/0044853.

The preferred forms of the invention described above are to be used as illustration only, and should not be used in a limiting sense to interpret the scope of the present inventive concept. Modifications to the exemplary embodiments, set forth above, could be readily made by those skilled in the art without departing from the spirit of the present inventive concept.

The inventors hereby state their intent to rely on the Doctrine of Equivalents to determine and assess the reasonably fair scope of the present inventive concept as it pertains to any apparatus not materially departing from but outside the literal scope of the invention as set forth in the following claims.

What is claimed is:

1. A power generating system comprising:
an engine that is operable to generate power; and
a water-to-hydrogen generator connected to the engine that is operable to generate and supply fuel to the engine at a rate that is equal to a rate required by the engine to run so that no excess fuel is generated.

2. The power generating system according to claim 1, further comprising:
at least one vibration electrical generator that is operable to capture vibration energy from the engine, convert the vibration energy into electricity, and transmit the electricity to power the water-to-hydrogen generator.

3. The power generating system according to claim 2, wherein the at least one vibration electrical generator includes one of (i) a first vibration electrical generator positioned directly on the engine to capture vibration energy transmitted directly from the engine, (ii) a second vibration electrical generator positioned on a part other than the engine to capture vibration energy transmitted indirectly from the engine, and (iii) a first vibration electrical generator positioned directly on the engine to capture vibration energy transmitted directly from the engine and a second vibration electrical generator positioned on a part other than the engine to capture vibration energy transmitted indirectly from the engine.

4. The power generating system according to claim 3, wherein the part is one of a vehicle hood, vehicle roof, vehicle fender, vehicle door panel, and vehicle axle.

5. The power generating system according to claim 2, further comprising:
a battery connected to the engine and the at least one vibration electrical generator, the battery operable to store electricity received from the at least one vibration electrical generator and to supply start-up power to the engine.

6. The power generating system according to claim 1, further comprising:
at least one solar collector that is operable to capture solar energy from an external source and convert the solar energy into electricity.

7. The power generating system according to claim 6, further comprising:
a battery connected to the engine and the at least one solar collector, the battery operable to store electricity received from the solar collector and to supply start-up power to the engine.

8. The power generating system according to claim 1, further comprising:
a fuel cell connected to the engine and the water-to-hydrogen generator, the fuel cell operable to (i) receive fuel from the water-to-hydrogen generator, (ii) produce electricity using the fuel received, and (iii) supply electricity to the engine.

9. The power generating system according to claim 1, further comprising:
an alternator connected to the engine, the battery, and the water-to-hydrogen generator, the alternator operable to be powered by the engine, to generate electricity, and to transmit the electricity to the battery and the water-to-hydrogen generator.

10. The power generating system according to claim 1, wherein the engine is one of a hydrogen combustion engine, a hydrogen combustion engine and an electric engine, and an electric engine, and the fuel generated by the water-to-hydrogen generator is hydrogen.

11. A method of generating power, the method comprising:
providing an engine that is operable to generate power; and
generating a supply of fuel for the engine via a water-to-hydrogen generator supply, the supply of fuel generated at a rate that is equal to a rate required by the engine to run so that no excess fuel is generated.

12. The method according to claim 11, further comprising the steps of:
(i) capturing vibration energy created by the engine, (ii) converting the vibration energy into electricity, and (iii) transmitting the electricity to power the water-to-hydrogen generator via at least one vibration electrical generator.

13. The method according to claim 12, wherein the at least one vibration electrical generator includes one of a (i) a first vibration electrical generator positioned directly on the engine to capture vibration energy transmitted directly from the engine, (ii) a second vibration electrical generator positioned on a part other than the engine to capture vibration energy transmitted indirectly from the engine, and (iii) a first vibration electrical generator positioned directly on the engine to capture vibration energy transmitted directly from the engine and a second vibration electrical generator positioned on a part other than the engine to capture vibration energy transmitted indirectly from the engine.

14. The method according to claim 13, wherein the part is one of a vehicle hood, vehicle roof, vehicle fender, vehicle door panel, and vehicle axle.

15. The method according to claim 12, further comprising the steps of:
(i) storing electricity received from the engine and the at least one vibration electrical generator in a battery, and (ii) supplying start-up power to the engine from the battery.

16. The method according to claim 11, further comprising the steps of:
(i) capturing solar energy from an external source, and (ii) convert the solar energy into electricity via at least one solar collector.

17. The method according to claim 16, further comprising the steps of:
(i) storing electricity received from the solar collector in a battery, and (ii) supplying start-up power to the engine from the battery.

18. The method according to claim 1, further comprising the steps of:
(i) receiving fuel from the water-to-hydrogen generator in a fuel cell, (ii) producing electricity in the fuel cell using the fuel, and (iii) transmitting the electricity to the engine to power the engine.

19. The method according to claim 11, further comprising the steps of:
(i) powering an alternator by the engine to produce electricity, (ii) charging the battery with the electricity produced by the alternator, and (iii) powering the water-to-hydrogen generator with the electricity produced by the alternator.

20. The method according to claim 11, wherein the engine is one of a hydrogen combustion engine, a hydrogen combustion engine and an electric engine, and an electric engine, and the fuel generated by the water-to-hydrogen generator is hydrogen.
